(19) United States
(12) Patent Application Publication
(10) Pub. No.: US 2010/0085598 A1
(43) Pub. Date: Apr. 8, 2010

(54) IMAGE PROCESSING APPARATUS, COMPLEX JOB EXECUTION METHOD AND RECORDING MEDIUM

(75) Inventors: Minako KOBAYASHI, Ikeda-shi (JP); Hirohisa Miyamoto, Kobe-shi (JP); Takehisa Yamaguchi, Ikoma-shi (JP); Katsuhiko Akita, Amagasaki-shi (JP)

Correspondence Address: MORRISON & FOERSTER LLP, 1650 TYSONS BOULEVARD, SUITE 400, MCLEAN, VA, 22102, US

(73) Assignee: Konica Minolta Business Technologies, Inc., Tokyo (JP)

(21) Appl. No.: 12/552,962

(22) Filed: Sep. 2, 2009

(30) Foreign Application Priority Data
Sep. 19, 2008 (JP) 2008-241814

(51) Int. Cl. G06F 3/12

(52) U.S. Cl. 358/1.15

(57) ABSTRACT

An image processing apparatus includes: an accepter that accepts a complex job including a plurality of jobs to be executed cooperatively by a plurality of image processing apparatuses including this image processing apparatus itself; a job controller that makes the plurality of image processing apparatuses including this image processing apparatus itself, cooperatively execute the plurality of jobs included in the accepted complex job; a job administrator that administers execution states of the respective jobs included in the complex job and generates job information pieces indicating job details and execution states of the respective jobs; and a memory that records in itself the generated job information pieces.

This application claims priority under 35 U.S.C. §119 to Japanese Patent Application No. 2008-241814 filed on Sep. 24, 2008, the entire disclosure of which is incorporated herein by reference in its entirety.

### BACKGROUND OF THE INVENTION

1. Field of the Invention

The present invention relates to an image processing apparatus such as an image forming apparatus, capable of accepting a complex job including a plurality of jobs to be executed cooperatively by a plurality of image processing apparatuses including this image processing apparatus itself, a complex job execution method, and a computer readable recording medium having a complex job execution program recorded therein to make a computer execute processing.

2. Description of the Related Art

The following description sets forth the inventor's knowledge of related art and problems therein and should not be construed as an admission of knowledge in the prior art.

Some image processing apparatuses that are multifunctional digital machines (Multi Function Peripherals) collectively having the copy function, the print function, the scan function, the data transmission function and other functions, are capable of accepting a complex job as mentioned above.

In other words, such image processing apparatuses cooperatively execute a plurality of jobs, for example as follows: a first image processing apparatus transmits image data read out from a document by a scanner, to a second image processing apparatus such as a personal computer; the second image processing apparatus converts the image data into a Word (word processing software by Microsoft Inc.) document and returns it to the first image processing apparatus; and the first image processing apparatus gives a user's signature to the document and makes it delivered to destinations by e-mail or etc.

As for administration of an execution state of a complex job cooperatively executed by a plurality of image processing apparatuses as described above, in the conventional practice, an administration server that centrally administers complex jobs is provided and the administration server administers complex jobs, meanwhile respective image processing apparatuses administer ordinary jobs executed independently by themselves.

As suggested in Japanese Unexamined Laid-open Patent Publication No. 2007-081771, for the purpose of checking execution results of jobs included in a complex job and executed cooperatively by image processing apparatuses, by operating any of the image processing apparatus, an inter-linkable cooperation table is provided in each of the image processing apparatuses and execution results of the jobs executed by the image processing apparatuses are written into their cooperation tables, respectively. And thus, this technology allows a user operating an image processing apparatus to check execution results of jobs executed by different image processing apparatuses, by accessing cooperation tables of the different image processing apparatuses.

However, if an administration server centrally administers execution states of complex jobs, users have to access the administration server to check an execution state of a complex job administered by the administration server, meanwhile users have to access an image processing apparatus to check an execution state of an ordinary job that is executed by one image processing apparatus contrary to a complex job cooperatively executed by a plurality of image processing apparatuses, issued and administered by the image processing apparatus. In other words, users have to access different location, which has been really troublesome.

According to the Japanese Unexamined Laid-open Patent Publication No. 2007-081771, a user operating an image processing apparatus is allowed to check execution results of jobs included in a complex job and executed by different image processing apparatuses, by accessing cooperation tables of the different image processing apparatuses. However, this publication does not resolve the above-mentioned problem that users have to access different locations to check execution states of an ordinary job and a complex job.

The description herein of advantages and disadvantages of various features, embodiments, methods, and apparatus disclosed in other publications is in no way intended to limit the present invention. Indeed, certain features of the invention may be capable of overcoming certain disadvantages, while still retaining some or all of the features, embodiments, methods, and apparatus disclosed therein.

### SUMMARY OF THE INVENTION

The preferred embodiments of the present invention have been developed in view of the above-mentioned and/or other problems in the related art. The Preferred embodiments of the present invention can significantly improve upon existing methods and/or apparatuses.

It is an object of the present invention to provide an image processing apparatus that is capable of administrating an execution state of a complex job that includes a plurality of jobs cooperatively executed, just like in the manner as administering an execution state of an ordinary job that is not a complex job.

It is another object of the present invention to provide a complex job execution method implemented by the image processing apparatus.

It is yet another object of the present invention to provide a computer readable recording medium having a program recorded therein to make a computer of the image processing apparatus implement the complex job execution method.

According to a first aspect of the present invention, an image processing apparatus comprises:
an accepter that accepts a complex job including a plurality of jobs to be executed cooperatively by a plurality of image processing apparatuses including this image processing apparatus itself, which is given by a user to this image processing apparatus itself;
a job controller that makes the plurality of image processing apparatuses including this image processing apparatus itself, cooperatively execute the plurality of jobs included in the complex job accepted by the accepter;
a job administrator that administers execution states of the respective jobs included in the complex job, and generates job information pieces indicating job details and execution states of the respective jobs; and
a memory that records in itself the job information pieces generated by the job administrator.

According to a second aspect of the present invention, a complex job execution method of the image processing apparatus comprises:
accepting a complex job including a plurality of jobs to be executed cooperatively by a plurality of image processing apparatuses, which is given by a user to one of the image processing apparatuses;
making the plurality of image processing apparatuses cooperatively execute the plurality of jobs included in the accepted complex job;
administering execution states of the respective jobs included in the complex job, and generating job information pieces indicating job details and execution states of the respective jobs; and
recording the generated job information pieces into the memory.

According to a third aspect of the present invention, a computer readable recording medium having a complex job execution program recorded therein to make a computer of the image processing apparatus execute:
accepting a complex job including a plurality of jobs to be executed cooperatively by a plurality of image processing apparatuses, which is given by a user to one of the image processing apparatuses;
making the plurality of image processing apparatuses cooperatively execute the plurality of jobs included in the accepted complex job;
administering execution states of the respective jobs included in the complex job, and generating job information pieces indicating job details and execution states of the respective jobs; and
recording the generated job information pieces into the memory.

The above and/or other aspects, features and/or advantages of various embodiments will be further appreciated in view of the following description in conjunction with the accompanying figures. Various embodiments can include and/or exclude different aspects, features and/or advantages where applicable. In addition, various embodiments can combine one or more aspect or feature of other embodiments where applicable. The descriptions of aspects, features and/or advantages of particular embodiments should not be construed as limiting other embodiments or the claims.

### BRIEF DESCRIPTION OF THE DRAWINGS

The preferred embodiments of the present invention are shown by way of example, and not limitation, in the accompanying figures, in which:

FIG. 1 is a view showing an example of a complex job;

FIG. 2 is a block diagram showing a functional configuration of an image processing apparatus;

FIG. 3 is a view showing job information generated by a job administrator;

FIG. 4 is flowchart representing a procedure to generate job information, executed by the job administrator;

FIG. 5 is a view showing a job information list (a job list) displayed on a display of an operation panel;

FIG. 6 is a view showing a next screen displayed when a “log list” button is pressed via the screen of FIG. 5;

FIG. 7 is a flowchart representing a procedure to display a list of the active jobs, shown in FIG. 5;

FIG. 8 is a flowchart representing a procedure to display a log list of the completed jobs, shown in FIG. 6;

FIG. 9 is a view to explain how to execute a complex job if data is necessary to execute some of the jobs but unnecessary to execute the other jobs, in another embodiment of the present invention; and

FIG. 10 is a flowchart representing a procedure how to do with data when a complex job is executed, if the data is necessary to execute a job included in the complex job.

### DETAILED DESCRIPTION OF THE PREFERRED EMBODIMENTS

In the following paragraphs, some preferred embodiments of the invention will be described by way of example and not limitation. It should be understood based on this disclosure that various other modifications can be made by those in the art based on these illustrated embodiments.

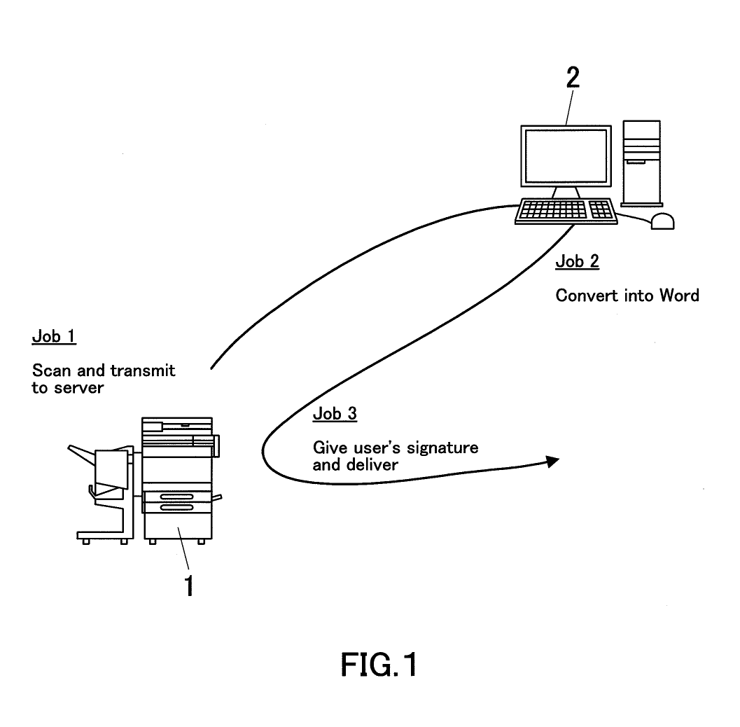

FIG. 1 is a view to explain an example of a complex job.

In FIG. 1, the number 1 corresponds to an image forming apparatus as an example of an image processing apparatus. In this embodiment, a MFP that is a multifunctional digital machine collectively having a plurality of functions such as the copy function, the print function and the facsimile function, as mentioned above, is employed.

The MFP 1 is capable of accepting complex jobs issued by users. A complex job corresponds to one set of a plurality of jobs to be executed cooperatively by a plurality of image processing apparatuses including the MFP 1 itself. For example, a complex job consists of the three jobs, jobs 1, 2 and 3, to be sequentially executed as follows. Job 1: a document is scanned by the MFP 1 and obtained image data is transmitted to a server 2. Job 2: the image data is converted into Word data by the server 2. Job 3: a signature is given by a user operating the MFP 1, to the Word data converted from the image data by the server 2, then delivered to predetermined destinations.

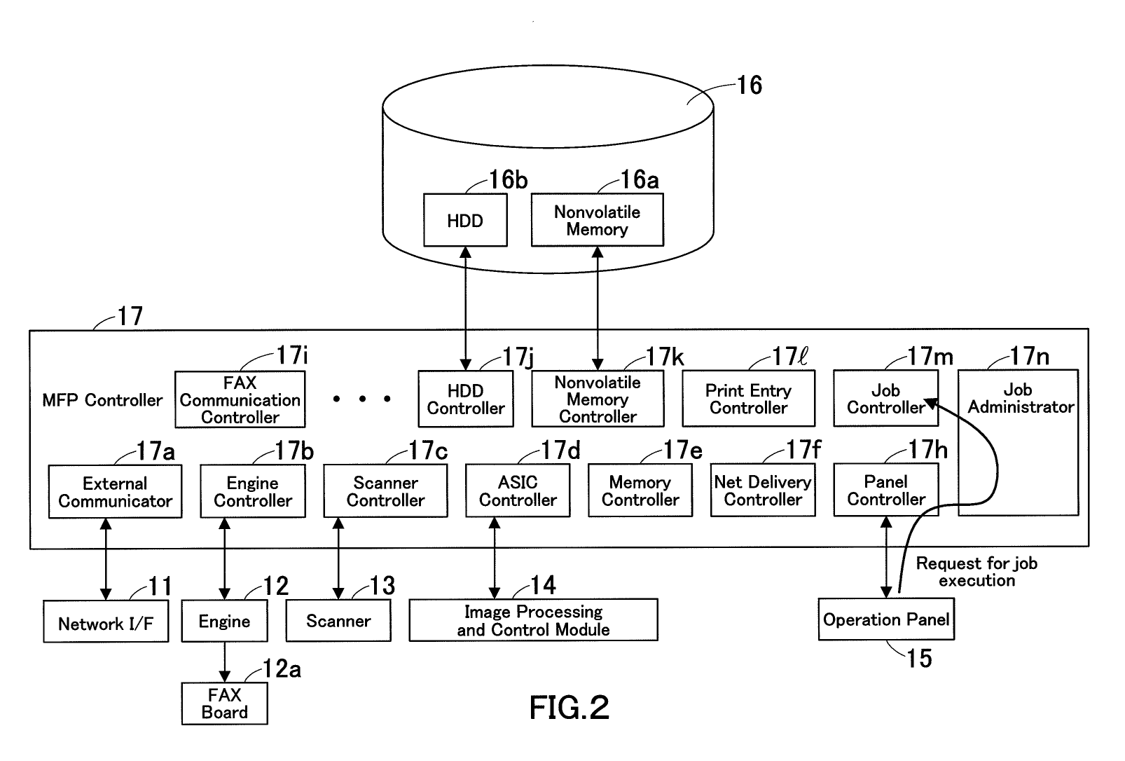

FIG. 2 is a block diagrams showing a functional configuration of the MFP 1.

As shown in FIG. 2, this MFP 1 includes a network interface (network I/F) 11, an engine 12, a scanner 13, an image processing and control module 14, an operation panel 15, a memory 16, a controller 17 and etc.

The network interface 11 serves to communicate with external apparatuses such as the server 2, via a network.

The engine 12 is a printer that prints out document data and etc. A FAX board 12a is connected to this engine 12.

The scanner 13 reads an image on a document and converts it into image data that is electronic data.

The image processing and control module 14 performs image processing in a predetermined manner on image data read out from a document by the scanner 13, before it is printed out.

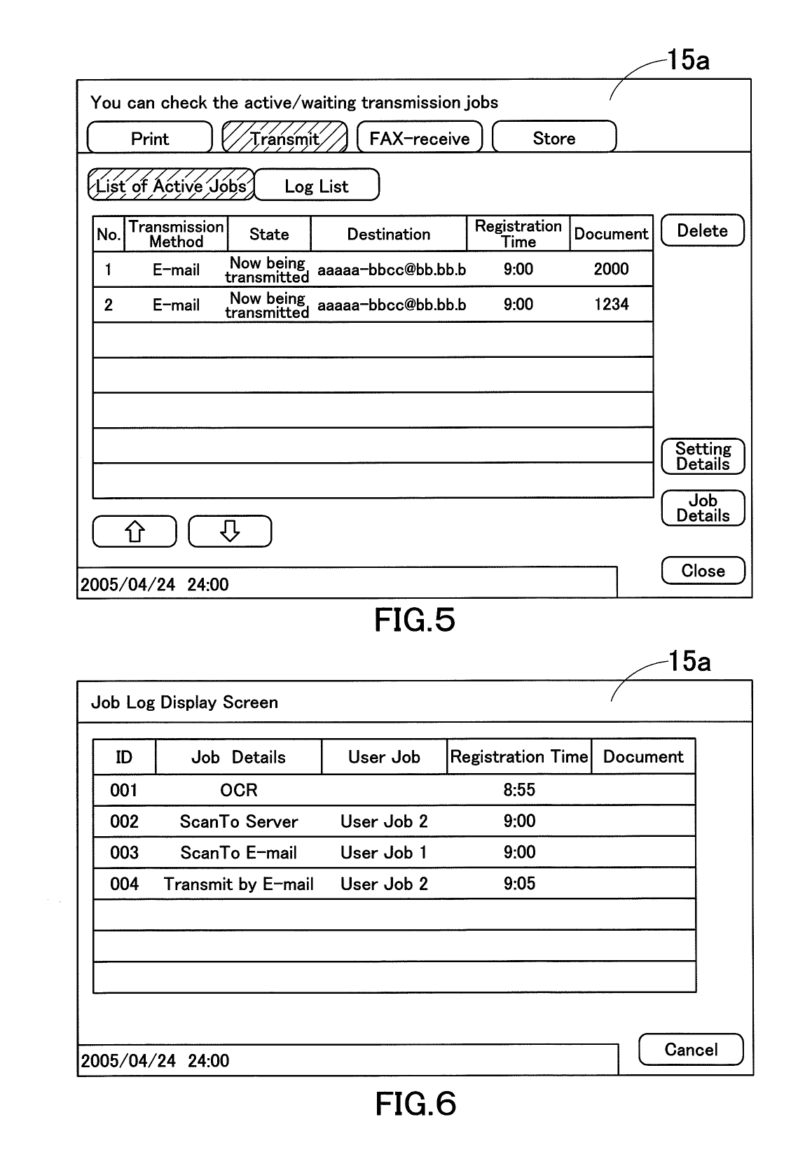

The operation panel 15 includes a key entry portion (not shown in Figure) having numeric keys, a start key and other keys, and a display 15a (shown in FIG. 5 and FIG. 6) such as a liquid crystal display with touch panel functionality. The operation panel 15 is used by users for a login operation, various entry operations and other operations, and is capable of displaying execution states of jobs including complex jobs, on the display 15a.

The memory 16 includes: a nonvolatile memory 16a that records in itself user information and other data; a hard disk drive (HDD) 16b that records in itself job information including job details and execution states of jobs, image data and other data; and other portions. And the hard disk drive 16b has a plurality of Boxes that are memory areas, created therein. Those are personal Boxes owned by respective users, group Boxes shared with group members, shared Boxes allowing unspecified users to access, and other Boxes.

The controller 17 includes an external communicator 17a capable of communicating with external apparatuses connected to a network, via the network interface 11, an engine controller 17b, a scanner controller 17c, an ASIC (Application Specific Integrated Circuit) controller 17d that controls the image processing and control module 14, a memory controller 17e, a net delivery controller 17f, an panel controller 17h that controls the operation panel 15, a FAX communication controller 17i that controls operations related to FAX communications, a HDD controller 17j that controls the HDD 16b, a nonvolatile memory controller 17k that controls the nonvolatile memory 16a, a print entry controller 171, a job controller 17m that controls job executions, and a job administrator 17n that administers execution states of jobs and generates job information including job details and execution results of jobs.

The controller 17 consists of a CPU, a ROM, a RAM and etc. not shown in Figure.

A user logs in this image forming apparatus 1 and issues a job, by operating the operation panel 15. Then, as indicated by an arrow shown in FIG. 2, the issued job, no matter it is a complex job or an ordinary job (an ordinary job is executed by one image processing apparatus contrary to a complex job cooperatively executed by a plurality of image processing apparatuses), is transmitted to the job administrator 17n. And by the job administrator 17n, the job is accepted, job information of the job is generated, and the job is further transmitted to the job controller 17m. And job execution is controlled by the controller 17m. Furthermore, the generated job information is updated by the job administrator 17n, according to the progress of job execution.

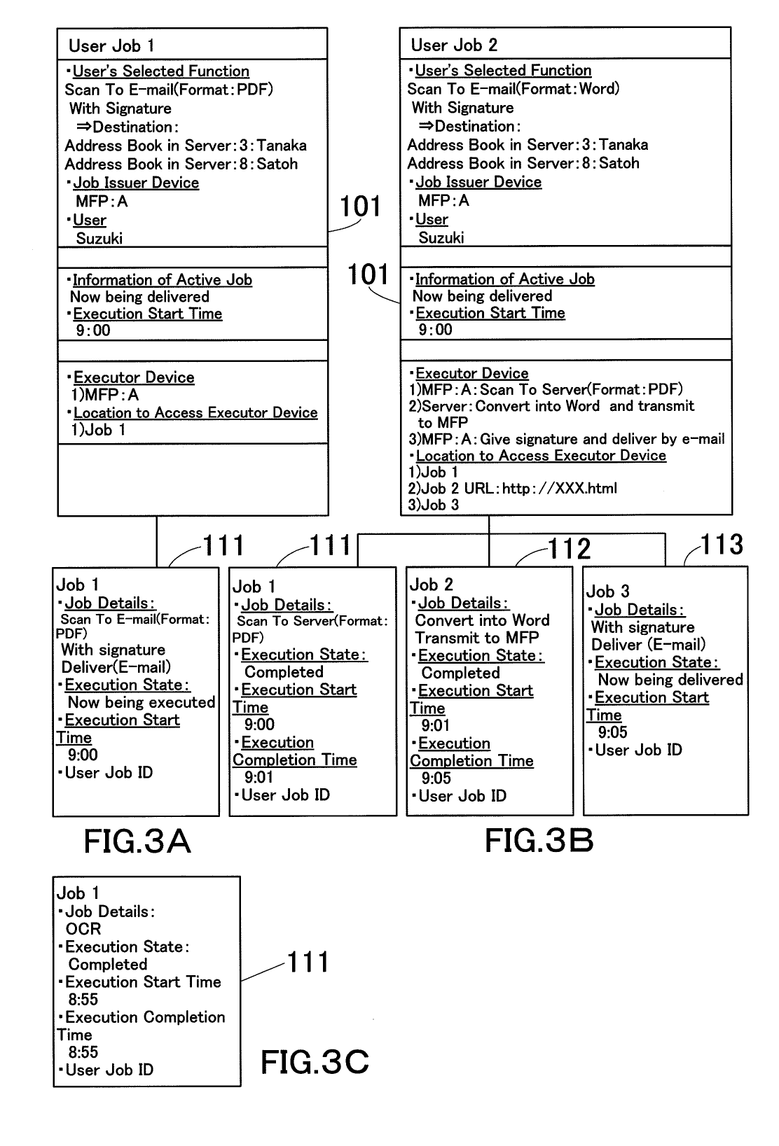

FIG. 3 shows job information generated by the job administrator 17n. In this embodiment, there is a difference in forms between the job information of a job directly given to the MFP 1 by a user (also referred to as “user job”), for example an ordinary job issued by a user operating the operation panel 15, and the job information of a job that is included in a complex job given by a user operating a different device and is received from a different device.

FIG. 3(A) shows a user job 1 that is an ordinary job. FIG. 3(B) shows a user job 2 that is a complex job.

Job information of a user job consists of overview information 101 indicating an overview of the user job, and constituent job information pieces 111, 112 and 113, each indicating job details of each constituent job. The overview information 101 includes the following information pieces: “user's selected function” that is a function selected by a user among those of the MFP 1; “job issuer device” that is a MFP operated to issue the job; “user” that is the user who issued the job; “information of active job” that is information of the active jobs; “execution start time” that is a start time of job execution, “executor device” that is a device to execute the job; and “location to access the executor device” that is locations of the respective execution devices to execute the job.

The constituent job information pieces 111, 112 and 113 consist of “job details”, “execution state”, “execution start time”, “execution completion time”, “user job ID” to identify user jobs, and other information, of the respective jobs.

Since the user job 1 shown in FIG. 3(A) is an ordinary job, one constituent job information piece 111 is given thereto. Thus, one overview information 101 and one constituent job information piece 111 are interconnected and recorded in the HDD 16b. In this embodiment, for example, the user job 1 is a job to scan a document, convert to the PDF form, give a signature, and transmit to predetermined destinations by e-mail.

The user job 2 shown in FIG. 3(B) is a complex job consisting of the three jobs, jobs 1, 2 and 3. Thus, one overview information 101 and three constituent job information pieces 111, 112 and 113 of the respective jobs are interconnected and recorded in the HDD 16b. In this embodiment, for example, the user job 2 is a complex job consisting of the three jobs, jobs 1, 2 and 3, to be sequentially executed as follows. Job 1: a document is scanned by the MFP 1 and obtained image data is transmitted to a server 2. Job 2: the image data is converted into Word data by the server 2. Job 3: a signature is given by a user operating the MFP 1, to the Word data converted from the image data by the server 2, then delivered to predetermined destinations.

As for a job that is received by the MFP 1 from a different device and included in a complex job issued by operating the different device, the job administrator 17n generates job information consisting of a constituent job information piece 111 only, and does not generate overview information 101, as shown in FIG. 3(C).

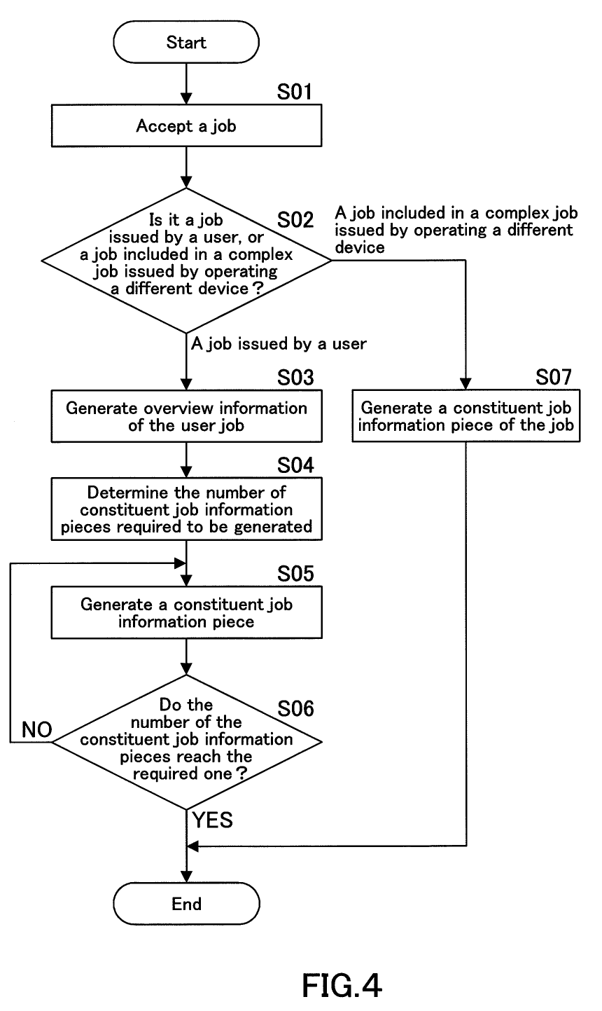

FIG. 4 is a flowchart representing a procedure to generate job information, executed by the job administrator 17n. This procedure is executed by a CPU constituting the controller 17, according to a job information RAM that is an operation program recorded in a recording medium such as the ROM not shown in Figure.

In Step S01, a job is accepted, then it is judged in Step S02, the accepted job is whether a job issued by a user, or a job included in a complex job issued by a different device.

If it is a job issued by a user, the routine proceeds to Step S03, in which overview information of the job is generated based on the fact that the job is a user job. Then the number of constituent job information pieces required to be generated is determined in Step S04, and a constituent job information piece of a first job is generated in Step S05. And it is judged in Step S06, whether or not the number of the generated constituent job information pieces reaches the required one.

If it does not reach the required number (NO in Step S06), the routine goes back to Step S05, in which a constituent job information piece of a next job is generated. If it reaches the required number (YES in Step S06), the routine terminates.

Meanwhile, if it is judged in Step S02 that the accepted job is a job included in a complex job issued by a different device, a constituent job information piece of the job is generated in Step S07, then the routine terminates.

The job information pieces including job details of the jobs, generated in this way, are updated by the job administrator 17n, according to the progress of job execution.

As described above, in this embodiment, as for a user job that is a complex job, job information consisting of overview information and constituent job information pieces of the respective jobs is generated, and the job information is recorded in the memory 16 of the MFP 1. Thus, the MPF 1 can provide an execution state of a complex job anytime when a user requests.

Furthermore, overview information of a user job is generated but overview information of a job included in a complex job issued by a different device is not generated. Thus, the MFP 1 also can display separately, job information of a user job and job information of a job included in a complex job issued by operating a different device.

FIG. 5 is a view showing a job information list (job list) displayed on the display 15a of the operation panel 15. As hatched in this example, a “transmit” button and a “list of active jobs” button are selected, and accordingly a list of the transmission jobs now being executed is displayed. No. 1 in the list of FIG. 5 corresponds to an ordinary job that is the user job 1, and No. 2 in the list corresponds to the job 3 included in the user job 2.

As described above, in this embodiment, ordinary jobs and complex jobs are displayed in the same job list only if they are user jobs.

As for a complex job including a job to be executed by the server 2, link information to link a job information piece of the job now being executed by the server 2, which is recorded in the server 2, may be generated and displayed, or information of the job may be obtained from the server 2 and displayed.

When the user job 2 corresponding to No. 2 in the list then a “details” button is pressed, execution states of the jobs 1, 2 and 3 constituting the user job 2 can be checked.

When a “log list” button is pressed via the screen of FIG. 5, the screen is switched to a screen shown in FIG. 6.

ID 001 of FIG. 6 does not have data in the “user job” column. This means it is a job included in a complex job issued by a different device.

ID 002 of FIG. 6 indicates that the job 1 included in the user job 2 has been executed, ID 003 indicates that the user job 1 has been executed, and ID 004 indicates that the job 3 included in the user job 2 has been executed.

As shown in the job log list screen of FIG. 6, ordinary jobs and complex jobs are displayed in the same job list only if they are user jobs. Thus, users do not have to access an administration server to check an execution state of a complex job any more, and are allowed to check an execution state of a complex job just like in the manner as checking an execution state of an ordinary job.

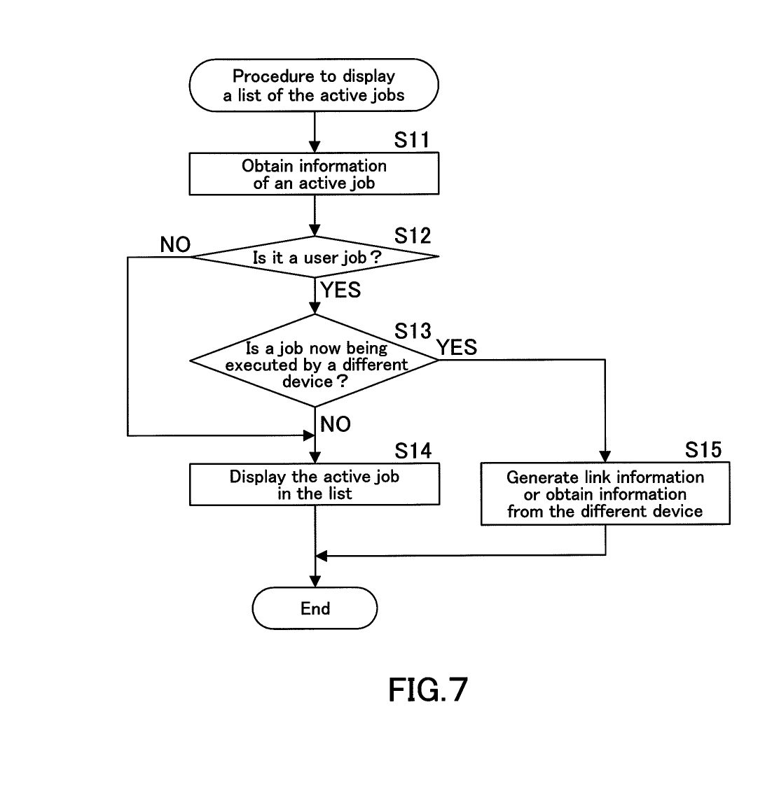

FIG. 7 is a flowchart representing a procedure to display a list of the active jobs, shown in FIG. 5. This procedure is executed by a CPU constituting the controller 17 according to a job information RAM that is an operation program recorded in a recording medium such as the ROM not shown in Figure.

In Step S11, information of an active job is obtained. And in Step S12, it is judged whether or not the job is a user job.

If it is a user job (YES in Step S12), then it is judged in Step S13, whether or not it is a job now being executed by a different device, which is included in a complex job. If it is not a job now being executed by a different device (NO in Step S13), the active job is displayed in the list in Step S14. Also, in Step S12, if the obtained job is not a user job (NO in Step S12), the job is displayed in the list in Step S14.

In Step S13, if it is a job now being executed by a different device (YES in Step S13), then in Step S15, link information to link a job information piece of the job, which is recorded in the different device, may be generated and displayed, or information of the job may be obtained from the different device and displayed.

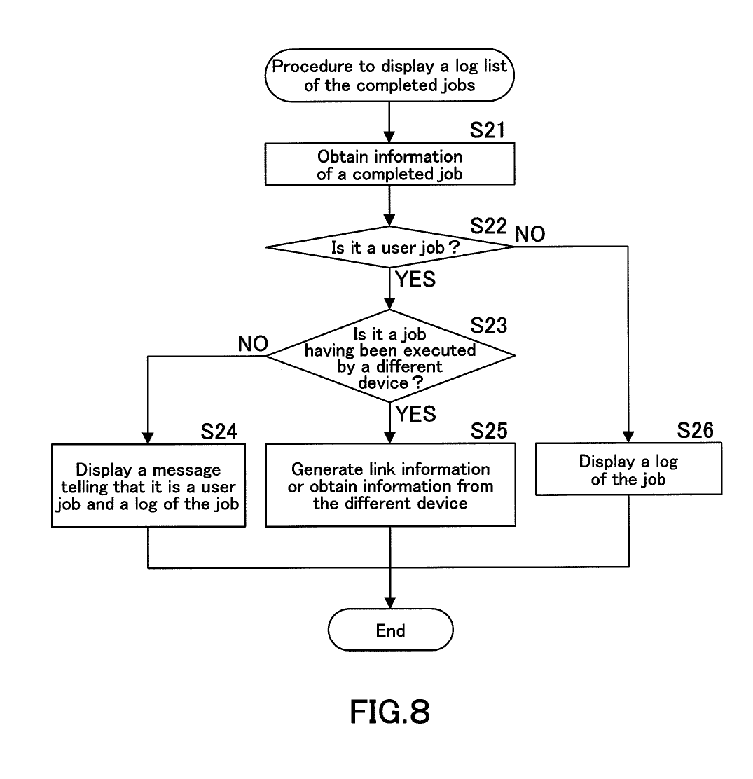

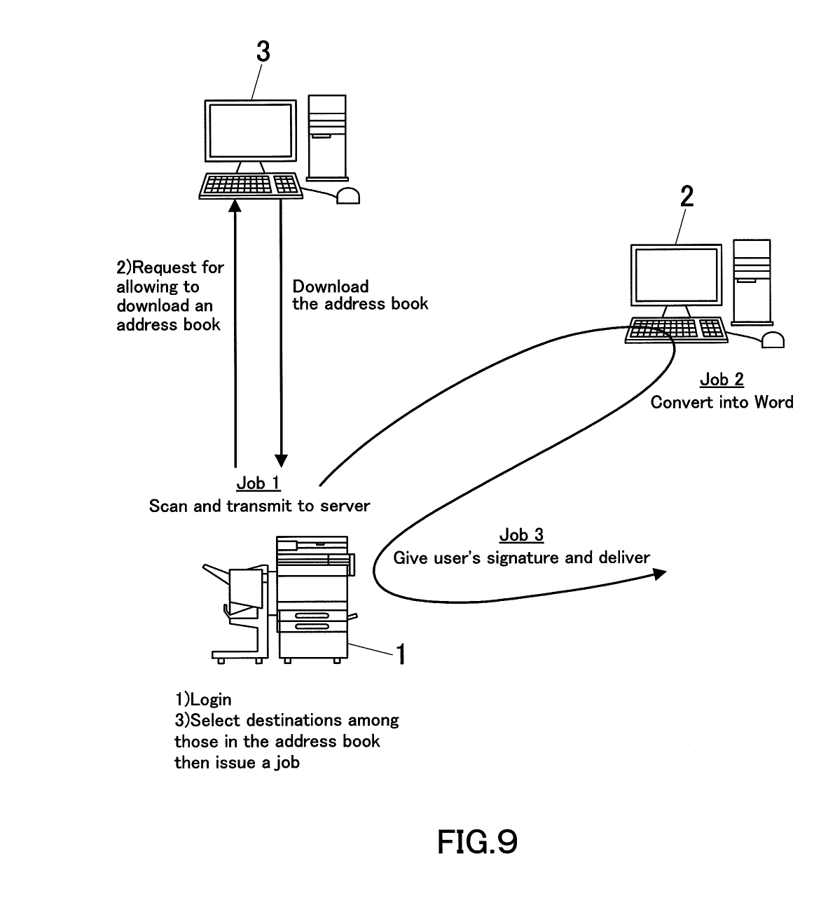

FIG. 8 is a flowchart representing a procedure to display a log list of the completed jobs, shown in FIG. 6. This procedure is executed by a CPU constituting the controller 17, according to a job information RAM that is an operation program recorded in a recording medium such as the ROM not shown in Figure.

In Step S21, information of a completed job is obtained. And in Step S22, it is judged whether or not the job is a user job. If it is not a user job (NO in Step S22), a log of the job is displayed in Step S26.

If it is a user job (YES in Step S22), then it is judged in Step S23, whether or not it is a job having been executed by a different device, which is included in a complex job.

If it is not a job having been executed by a different device (NO in Step S23), a message telling that it is a user job and a log of the job are displayed in Step S24. If it is a job having been executed by a different device (YES in Step S23), then in Step S25, link information to link a job information piece of the job, which is recorded in the different device, may be generated and displayed, or a log of the job may be obtained from the different device and displayed.

FIG. 9 is a view to explain how to execute a complex job if data is necessary to execute some of the jobs but unnecessary to execute the other jobs, in another embodiment of the present invention.

In this embodiment, just like in the embodiment previously explained with FIG. 1, a complex job consists of the three jobs, jobs 1, 2 and 3, to be sequentially executed as follows. Job 1: a document is scanned by the MFP 1 and obtained image data is transmitted to the server 2. Job 2: the image data is converted into Word data by the server 2. Job 3: a signature is given by a user operating the MFP 1, to the Word data converted from the image data by the server 2, then delivered to predetermined destinations. However, in the job 3, the user selects destinations of the Word data having the signature given thereto, among those in an address book downloaded from a server 3.

In other words, as illustrated in FIG. 9, the user performs as follows: (1) log in the MFP 1; (2) request the server 3 for allowing to download an address book; and (3) select destinations among those in the address book downloaded from the server 3, then issue a job.

Thus, an address book downloaded from a different device is necessary to execute the job 3.

As described above, in this embodiment, if data is necessary to execute some jobs included in a complex job, the job administrator 17n determines about each job, whether or not data is necessary to execute the job, and the job controller 17m provides necessary data to such a job and executes the job.

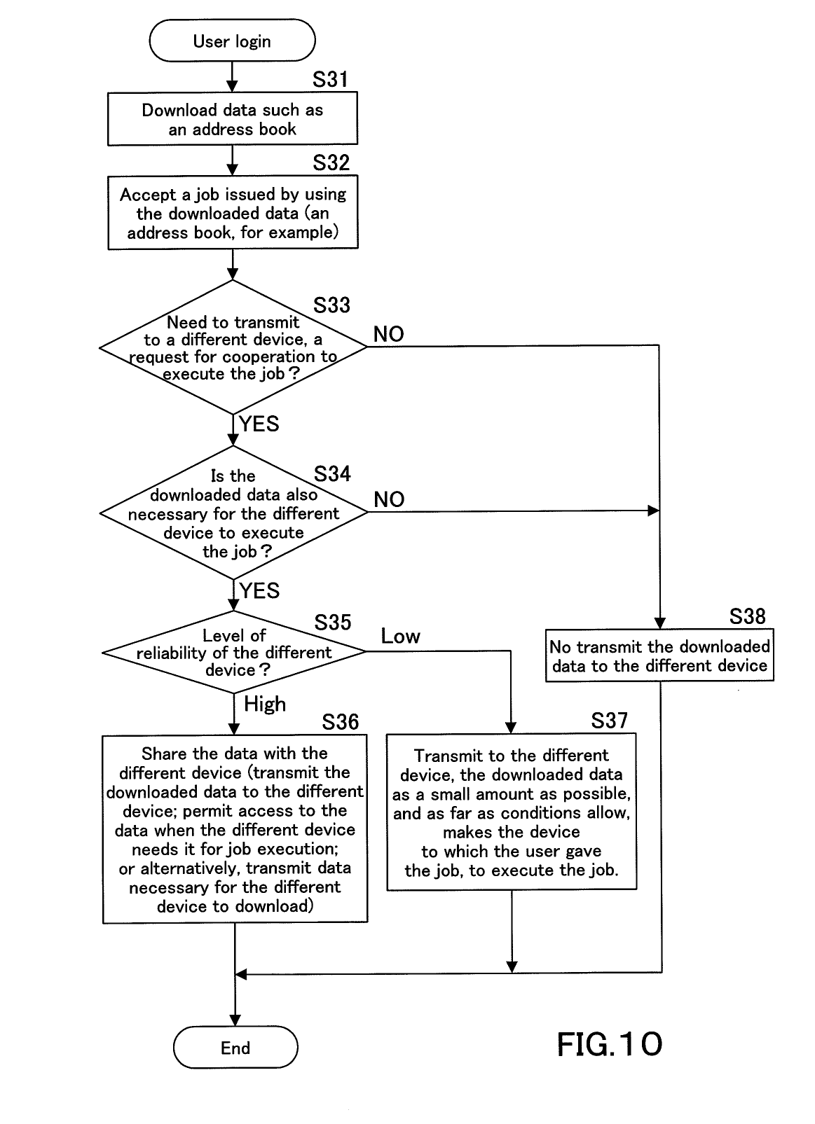

FIG. 10 is a flowchart representing a procedure how to do with data when a job is executed, if the data is necessary to execute the job as described above. This procedure is executed by a CPU constituting the controller 17, according to a job information RAM that is an operation program recorded in a recording medium such as the ROM not shown in Figure.

In Step S31, data such as an address book is downloaded. And in Step S32, a job issued by using the downloaded data is accepted.

Subsequently in Step S33, it is judged whether or not a request for cooperation to execute a job is needed to be transmitted to a different device, in other words, it is judged whether or not it is a complex job including a job to be executed by a different device.

If a request for cooperation to execute a job is needed to be transmitted to a different device (YES in Step S33), then it is judged in Step S34, whether or not the downloaded data is also necessary for the different device to execute the job.

If downloaded data is also necessary for the different device to execute the job (YES in Step S34), then it is judged in Step S34, whether or not a level of reliability of the different device is high enough. For example, this judgment is made based on whether or not security is ensured, a manufacturer of the different device, or another factor.

If the level of reliability is high enough (YES in Step S35), the routine proceeds to Step S36, in which the data is shared with the different device. In other words, the downloaded data is transmitted to the different device, or the different device is permitted to access the data when needs it for job execution. Or alternatively, data necessary for the different device to download is transmitted.

Meanwhile, if the level of reliability is low (NO in Step S35), the routine proceeds to Step S37, in which the downloaded data as a small amount as possible is transmitted to the different device, and the job is executed by the device to which the user gave the job, as far as conditions allow.

Meanwhile, in Step S33, if a request for cooperation to execute the job is not needed to be transmitted to the different device (NO in Step S33), and if downloaded data is not necessary to execute the job by the different device (NO in Step S34), the routine proceeds to Step S38, in which the downloaded data is not transmitted to the different device.

As described above, if data is not necessary for a different device to execute a job, the data is not transmitted to the different device. Thus, the inconvenience that data unnecessary to execute jobs is sequentially transferred among devices according to the progress of cooperative job execution, is eliminated, and a procedure to execute a complex job is simplified.

While the present invention may be embodied in many different forms, a number of illustrative embodiments are described herein with the understanding that the present disclosure is to be considered as providing examples of the principles of the invention and such examples are not intended to limit the invention to preferred embodiments described herein and/or illustrated herein.

While illustrative embodiments of the invention have been described herein, the present invention is not limited to the various preferred embodiments described herein, but includes any and all embodiments having equivalent elements, modifications, omissions, combinations (e.g. of aspects across various embodiments), adaptations and/or alterations as would be appreciated by those in the art based on the present disclosure. The limitations in the claims are to be interpreted broadly based on the language employed in the claims and not limited to examples described in the present specification or during the prosecution of the application, which examples are to be construed as non-exclusive. For example, in the present disclosure, the term “preferably” is non-exclusive and means “preferably, but not limited to”. In this disclosure and during the prosecution of this application, means-plus-function or step-plus-function limitations will only be employed where for a specific claim limitation all of the following conditions are present In that limitation: a) “means for” or “step for” is expressly recited; b) a corresponding function is expressly recited; and c) structure, material or acts that support that structure are not recited. In this disclosure and during the prosecution of this application, the terminology “present invention” or “invention” may be used as a reference to one or more aspect within the present disclosure. The language present invention or invention should not be improperly interpreted as an identification of criticality, should not be improperly interpreted as applying across all aspects or embodiments (i.e., it should be understood that the present invention has a number of aspects and embodiments), and should not be improperly interpreted as limiting the scope of the application or claims. In this disclosure and during the prosecution of this application, the terminology “embodiment” can be used to describe any aspect, feature, process or step, any combination thereof, and/or any portion thereof, etc. In some examples, various embodiments may include overlapping features. In this disclosure and during the prosecution of this case, the following abbreviated terminology may be employed: “e.g.” which means “for example”, and “NB” which means “note well”.

What is claimed is:

1. An image processing apparatus comprising:
an accepter that accepts a complex job including a plurality of jobs to be executed cooperatively by a plurality of image processing apparatuses including this image processing apparatus itself, which is given by a user to this image processing apparatus itself;
a job controller that makes the plurality of image processing apparatuses including this image processing apparatus itself, cooperatively execute the plurality of jobs included in the complex job accepted by the accepter;
a job administrator that administers execution states of the respective jobs included in the complex job, and generates job information pieces indicating job details and execution states of the respective jobs; and
a memory that records in itself the job information pieces generated by the job administrator.

2. The image processing apparatus recited in claim 1, wherein:
the job administrator administers an execution state of an ordinary job that is not a complex job, and generates job information of the single job when the job controller makes this image processing apparatus itself execute the single job.

3. The image processing apparatus recited in claim 1, further comprising:
a display portion, and
wherein:
the job administrator makes the display portion display a job information piece appropriate for an execution state of the complex job, among the job information pieces of the respective jobs included in the complex job, which are recorded in the memory.

4. The image processing apparatus recited in claim 1, wherein:
the job administrator determines whether or not data is necessary to execute the respective jobs included in the complex job, and the job controller provides the necessary data to the respective jobs and makes the jobs executed.

5. A complex job execution method comprising:
accepting a complex job including a plurality of jobs to be executed cooperatively by a plurality of image processing apparatuses, which is given by a user to one of the image processing apparatuses;
making the plurality of image processing apparatuses cooperatively execute the plurality of jobs included in the accepted complex job;
administering execution states of the respective jobs included in the complex job, and generating job information pieces indicating job details and execution states of the respective jobs; and
recording the generated job information pieces into the memory.

6. The complex job execution method recited in claim 5, wherein:
an execution state of an ordinary job that is not a complex job, is administered, and a job information piece of the single job is generated when the single job is executed by the image processing apparatus to which the complex job is given.

7. The complex job execution method recited in claim 5, wherein:
a job information piece appropriate for an execution state of the complex job is displayed on a display portion, among the job information pieces of the respective jobs included in the complex job, which are recorded in the memory.

8. The complex job execution method recited in claim 5, wherein:
whether or not data is necessary to execute the respective jobs included in the complex job, is determined, and the necessary data is provided to the respective jobs and the jobs are executed.

9. A computer readable recording medium having a complex job execution program recorded therein to make a computer of an image processing apparatus execute:
accepting a complex job including a plurality of jobs to be executed cooperatively by a plurality of image processing apparatuses, which is given by a user to one of the image processing apparatuses;
making the plurality of image processing apparatuses cooperatively execute the plurality of jobs included in the accepted complex job;
administering execution states of the respective jobs included in the complex job, and generating job information pieces indicating job details and execution states of the respective jobs; and
recording the generated job information pieces into the memory.

10. The computer readable recording medium recited in claim 9, wherein:
an execution state of an ordinary job that is not a complex job, is administered, and a job information piece of the single job is generated when the single job is executed by the image processing apparatus to which the complex job is given.

11. The computer readable recording medium recited in claim 9, wherein:
a job information piece appropriate for an execution state of the complex job is displayed on a display portion, among the job information pieces of the respective jobs included in the complex job, which are recorded in the memory.

12. The computer readable recording medium recited in claim 9, wherein:
whether or not data is necessary to execute the respective jobs included in the complex job, is determined, and the necessary data is provided to the respective jobs and the jobs are executed.
